(19) United States
(12) Patent Application Publication
(10) Pub. No.: US 2025/0187567 A1
(43) Pub. Date: Jun. 12, 2025

(54) JACK ASSIST DEVICE

(71) Applicant: Donald Mills, Old Hickory, TN (US)

(72) Inventor: Donald Mills, Old Hickory, TN (US)

(21) Appl. No.: 18/978,189

(22) Filed: Dec. 12, 2024

Related U.S. Application Data
(60) Provisional application No. 63/609,047, filed on Dec. 12, 2023.

(51) Int. Cl. B60S 9/04

(52) U.S. Cl. CPC B60S 9/04

(57) ABSTRACT

A jack assist device may comprise a first member attachable to a crank handle of a semi-trailer landing gear. The first member may have an inner side with an arced divot and a first securing mechanism. A second member may extend orthogonally from the first member and may have an inner side with an arced divot and a second securing mechanism. A drive attachment mechanism may receive a drive shaft of a motorized tool. Rotation of the drive shaft may cause rotation of the crank handle. The securing mechanisms may be releasable. The drive attachment mechanism may comprise an aperture or a protrusion. The securing mechanisms may include magnets, clamps, or quick-release features.

### RELATED APPLICATION

Under provisions of 35 U.S.C. § 119(e), the Applicant claims the benefit of U.S. Provisional Application No. 63/609,047 filed on Dec. 12, 2023, which is incorporated herein by reference.

It is intended that the referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to mechanical tools for assisting in the operation of jacks and crank handles. More specifically, it pertains to devices for rotating crank handles on semi-trailer landing gear.

### BACKGROUND

Semi-trailer landing gear systems may include various designs and sizes of crank handles. The crank handles may be located in different positions on the trailer, depending on the specific model and/or manufacturer. Some crank handles may be difficult to access or operate in certain situations, such as when the trailer is positioned close to other vehicles or structures. Moreover, crank handles for semi-trailer landing gear are put through significant use and abuse on the road, leading to handles becoming bent and/or misshapen.

Manual operation of semi-trailer landing gear may be inefficient and/or physically demanding. For example, rotating the crank handle of semi-trailer landing gear may require significant physical effort, especially when performed repeatedly throughout a workday. The conventional strategy is to manually operate the crank handle using both hands. This often causes problems because the conventional strategy does not allow for one-handed operation or integration with power tools. For example, operators may experience fatigue and potential injuries from the repetitive manual cranking motion.

The process of raising or lowering a semi-trailer using conventional landing gear systems may be time-consuming. This may lead to delays in logistics operations, particularly in fast-paced shipping environments where efficiency is crucial. Additionally, the manual operation of landing gear may require operators to dedicate their full attention to the task, preventing them from performing other necessary duties simultaneously.

Existing methods for operating semi-trailer landing gear may not provide optimal versatility or adaptability. Different trailer models and configurations may require different approaches or tools for efficient operation. This lack of standardization may present challenges for operators who work with various types of trailers on a regular basis.

Safety concerns may arise from the physical nature of manually operating semi-trailer landing gear. The repetitive motion and force required to turn the crank handle may potentially lead to strain or injury, particularly over extended periods of use. These safety risks may be exacerbated in adverse weather conditions or when operators are working under time pressure.

Current approaches to semi-trailer landing gear operation may not fully address the need for quick attachment and detachment of assistive devices. Operators may benefit from solutions that allow for rapid engagement and disengagement with the crank handle, enabling them to switch between manual and assisted operation as needed.

The efficiency of logistics operations may be impacted by the time and effort required for manual landing gear adjustment. In industries where time is a critical factor, such as freight transportation and distribution, any delays in trailer preparation or positioning may have ripple effects throughout the supply chain.

### Brief Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A jack assist device may comprise a first member configured to attach to a crank handle of a semi-trailer landing gear. The first member may comprise an inner side having an arced divot spanning a length of the inner side, an outer side, and a first securing mechanism disposed on the inner side and configured to releasably secure the first member to a first section of the crank handle. The jack assist device may further comprise a second member extending orthogonally from the first member. The second member may comprise an inner side having an arced divot spanning a length of the inner side, an outer side, and a second securing mechanism disposed on the inner side and configured to releasably secure the second member to a second section of the crank handle. The jack assist device may also comprise a drive attachment mechanism configured to receive a drive shaft of a motorized tool. Rotation of the drive shaft may cause rotation of the crank handle.

A method for operating a jack assist device may comprise attaching a first member of the jack assist device to a first section of a crank handle of a semi-trailer landing gear using a first securing mechanism. The method may further comprise attaching a second member of the jack assist device to a second section of the crank handle using a second securing mechanism, wherein the second member extends orthogonally from the first member. The method may also comprise interfacing a drive shaft of a motorized tool with a drive attachment mechanism of the jack assist device. The method may additionally comprise rotating the drive shaft to cause rotation of the crank handle.

An apparatus for rotating a crank handle of a semi-trailer landing gear may comprise a first L-shaped member configured to partially encapsulate the crank handle. The first L-shaped member may comprise a first arm having an inner side with an arced divot, a second arm extending orthogonally from the first arm and having an inner side with an arced divot, and at least one securing mechanism disposed on at least one of the first arm or the second arm and configured to releasably secure the first L-shaped member to the crank handle. The apparatus may further comprise a drive attachment mechanism configured to receive a drive shaft of a motorized tool. Rotation of the drive shaft may cause rotation of the crank handle.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a front perspective view of a jack assist device consistent with embodiments of the present application;

FIG. 2 illustrates a rear perspective view of the jack assist device of FIG. 1;

FIG. 3 illustrates a side view of the jack assist device of FIG. 1;

FIG. 4 illustrates a front view of the jack assist device of FIG. 1;

FIG. 5 illustrates a rear view of the jack assist device of FIG. 1; and

FIG. 6 is a flowchart illustrating a method for operating the jack assist device.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of a jack assist device, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The jack assist device is a tool designed to make it easier and faster to operate the crank handle on semi-trailer landing gears. Semi trailer landing gear is retractable support equipment that helps to keep a trailer level when it's uncoupled from the semi-tractor. The landing gear may be located at or near the front of the trailer. The landing gear consists of two legs that can support the heavy weight of the trailer. Each leg may be adjustable via a crank interface. The crank interface may include a crank having a first member that extends along the axis of rotation, a second member that extend substantially orthogonally to the first member, and a handle that is substantially parallel to the first member. The second member provides an offset between the first member and the handle, allowing an operator to gain leverage in turning the crank handle to rotate the crank and adjust the length of the landing gear legs to support the semi trailer.

The jack assist device may include a generally L-shaped design with two main parts—a first member and a second member. The second member may extend at an approximate right angle from the first member. The first and second members may define a curved inner surface on both members that fits around the crank handle for the semi trailer landing gear (e.g., with the first member of the jack assist device extending along the first member of the crank handle and the second member of the jack assist device extending along the second member of the crank handle). Mechanisms such as (but not limited to) magnets or clamps may be used to securely (but releasably) attach the device to the crank handle. A protrusion on an exterior surface of the device may include a hole configured to connect to a power drill or other motorized tool for use in rotating the device. This device rotation may then cause rotation of the crank handle, allowing an operator to easily adjust the semi trailer landing gear.

The device allows for faster and easier operation of landing gears associated with various makes and/or models of semi trailer. The employment of the motorized tool reduces physical strain on the operator, and may allow for one-handed use, freeing up the operator's other hand. Overall, the device improves operator efficiency and ergonomics for truck drivers and warehouse workers who frequently need to raise and/or lower semi trailer landing gears.

Embodiments of the present disclosure may comprise one or more modules or components comprising, but not limited to, at least one of the following:
A. A Bracket
B. An Attachment Mechanism
C. A Tool Interface

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may comprise the following stages:
attaching a first member of the jack assist device to a first section of a crank handle of a semi-trailer landing gear using a first securing mechanism;
attaching a second member of the jack assist device to a second section of the crank handle using a second securing mechanism, wherein the second member extends orthogonally from the first member;
interfacing a drive shaft of a motorized tool with a drive attachment mechanism of the jack assist device; and
rotating the drive shaft to cause rotation of the crank handle.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

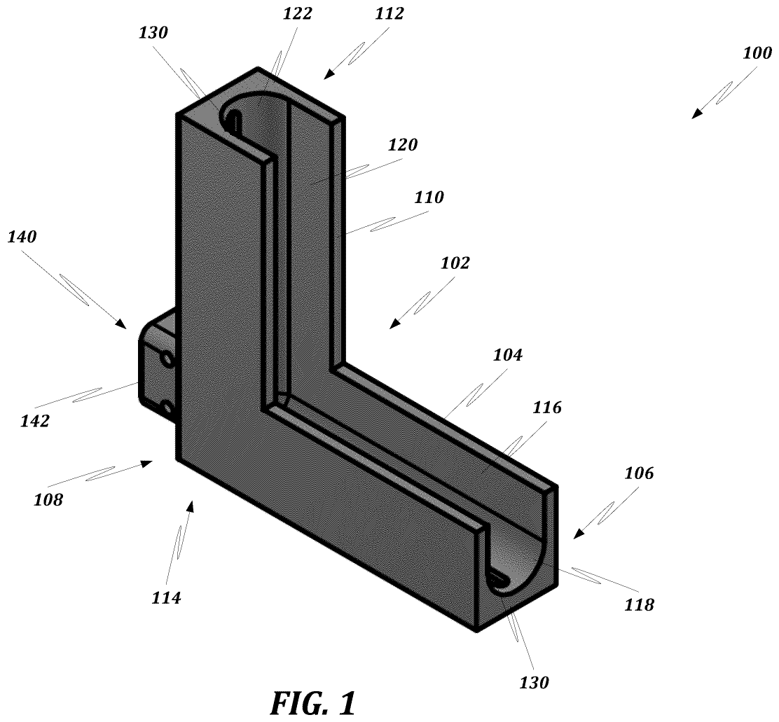

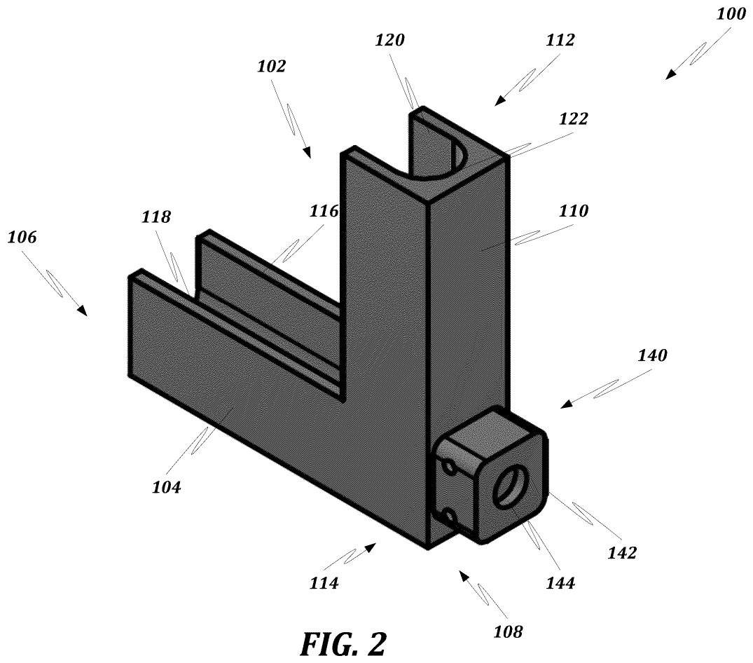

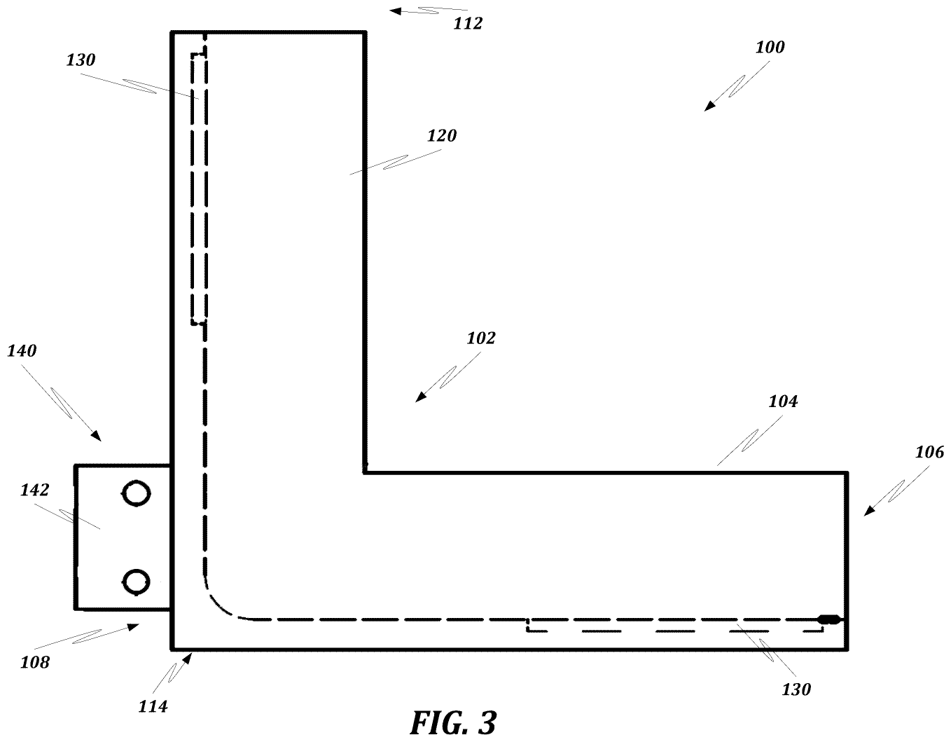

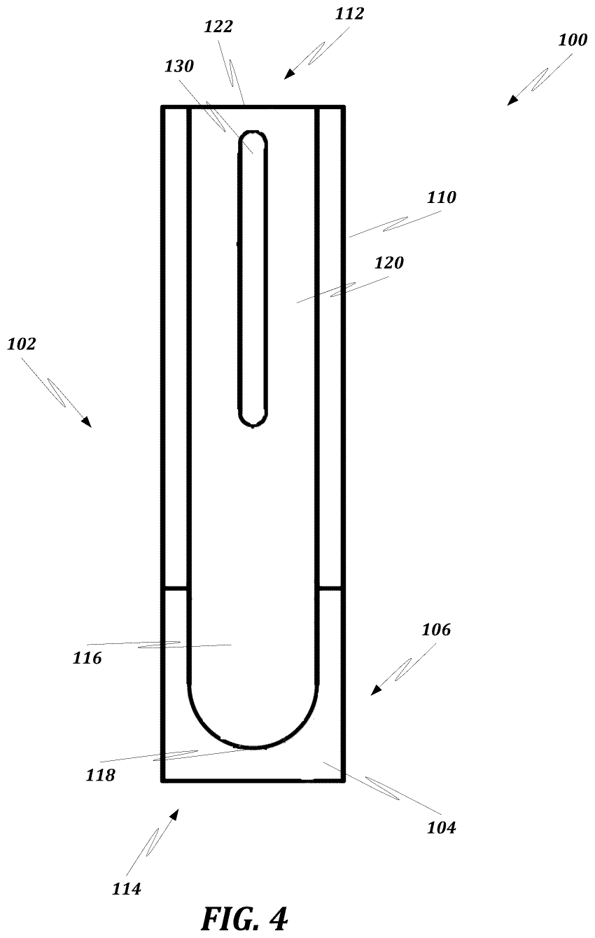

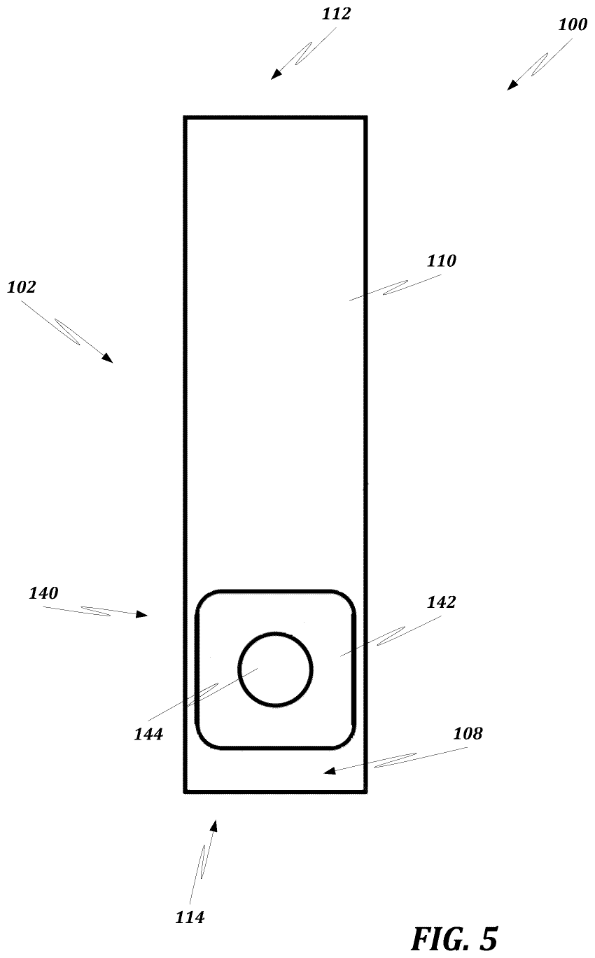

FIGS. 1-5 illustrate one possible embodiment of a jack assist device \hat{ }00. Embodiments of the present disclosure provide a device \hat{ }00 comprised of a distributed set of computing elements, including, but not limited to the following.

### A. A Bracket

As shown in FIGS. 1-5, the jack assist device \hat{ }00 may include a bracket \hat{ }02. The bracket \hat{ }02 may comprise a first member \hat{ }04 having a distal end \hat{ }06 and a connecting end \hat{ }08. A second member \hat{ }10 may include a distal end \hat{ }12 and a connecting end \hat{ }14 that connects to the connecting end \hat{ }08 of the first member \hat{ }04. The second member \hat{ }10 may extend substantially orthogonally from the first member \hat{ }04. In this way, the bracket \hat{ }02 may be generally L-shaped.

The first member \hat{ }04 may include an inner side \hat{ }16 defining a divot \hat{ }18 or channel along the inner side. The divot \hat{ }18 may have a rounded (e.g., semicircular in cross-section, generally U-shaped in cross section, etc.) shape, and may span the length of the inner side \hat{ }16. The size of the divot \hat{ }18 may be selected based at least in part on the size (e.g., the gauge) of the crank handle for the landing gears. That is, the size of the divot \hat{ }18 may be sufficient to accommodate landing gears of various gauges, from various manufacturers. The size of the divot \hat{ }18 may also be selected to allow for accommodation of deformed (e.g., bent, dented, etc.) crank handles. As one particular example, the divot \hat{ }18 may be generally U-shaped in cross-section, and may extend from the distal end \hat{ }06 to a point near the connecting end \hat{ }08.

The first member \hat{ }04 may have a length selected to be shorter than a length of the first member of the crank. As one particular example, the length of the first member \hat{ }04 may be approximately 7 inches.

In some embodiments, the inner side \hat{ }08 of the first member \hat{ }04 may also include a recess configured to receive a securing mechanism to releasably attach the bracket \hat{ }02 to a first section of a crank handle for semi-trailer landing gear.

The second member \hat{ }10 may include an inner side \hat{ }20 defining a divot \hat{ }22 or channel along the inner side. The divot \hat{ }22 may have a rounded (e.g., semicircular in cross-section, generally U-shaped in cross section, etc.) shape, and may span the length of the inner side \hat{ }20. The size of the divot \hat{ }22 may be selected based at least in part on the size (e.g., the gauge) of the crank handle for the landing gears. That is, the size of the divot \hat{ }22 may be sufficient to accommodate landing gears of various gauges, from various manufacturers. The size of the divot \hat{ }22 may also be selected to allow for accommodation of deformed (e.g., bent, dented, etc.) crank handles. As one particular example, the divot \hat{ }22 may be generally U-shaped in cross-section, and may extend from the distal end \hat{ }12 to a point near the connecting end \hat{ }14.

The second member \hat{ }10 may have a length selected to be shorter than a length of the second member of the crank. As one particular example, the length of the second member \hat{ }10 may be approximately 7 inches. The length may help to transfer torque from the bracket \hat{ }02 to the crank handle.

In some embodiments, the inner side \hat{ }20 of the second member \hat{ }10 may also include a recess configured to receive a securing mechanism to releasably attach the bracket \hat{ }02 to a second section of a crank handle for semi-trailer landing gear.

The bracket \hat{ }02 may be constructed of a durable material, such as a metal alloy and/or a composite plastic to withstand operational forces. In some embodiments, the first member \hat{ }04 and the second member \hat{ }10 may be formed separately and joined together (e.g., using fasteners, metal welds, plastic welds, and/or the like). Alternatively, the first member \hat{ }04 and the second member \hat{ }10 may be formed as a single, monolithic structure. In some embodiments, the second member \hat{ }10 may optionally be telescopic to accommodate different crank handle sizes.

Overall, the design of the bracket \hat{ }02 may provide a secure attachment to the landing gear crank handle while enabling motorized rotation of the handle. The orthogonal configuration of the first and second members allows the bracket \hat{ }02 to grip two sections of the handle for stability during operation.

### B. An Attachment Mechanism

In some embodiments, one or more (e.g., both) of the first member \hat{ }04 and the second member \hat{ }10 may include an attachment mechanism \hat{ }30. Each attachment mechanism \hat{ }30 may be configured to securely and releasably retain the crank handle of the landing gear within the bracket \hat{ }02. The attachment mechanism \hat{ }30 may include, as non-limiting examples, magnets, clamps, and/or other quick-release features to allow easy attachment and detachment.

In some embodiments, the attachment mechanism \hat{ }30 may include one or more magnets disposed within recesses in the inner sides \hat{ }08, \hat{ }20 of the first member \hat{ }04 and/or the second member \hat{ }10. The magnets may be configured to releasably secure the bracket \hat{ }02 to the crank handle of the landing gear. In some embodiments, the magnets may be neodymium magnets or other strong permanent magnets.

Alternatively or additionally, the attachment mechanism \hat{ }30 may comprise one or more clamps. The clamps may be spring-loaded or manually actuated clamps configured to grip the crank handle. The clamps may be disposed on the inner sides of the first member \hat{ }04 and second member \hat{ }10.

In some embodiments, the attachment mechanism \hat{ }30 may include a combination of magnets and clamps to provide secure attachment. The magnets and/or clamps may be adjustable to accommodate different sizes and shapes of crank handles.

The attachment mechanism \hat{ }30 may include quick-release features to allow for rapid attachment and/or detachment of the bracket \hat{ }02 from the crank handle. For example, the clamps may have lever-actuated quick-release mechanisms. The magnets may be mounted on sliding or pivoting elements to allow them to be quickly disengaged.

The recesses or mounting points for the attachment mechanism \hat{ }30 may be strategically positioned along the inner sides of the first member \hat{ }04 and second member \hat{ }10 to grip on the crank handle. In some embodiments, multiple attachment points may be provided to allow customization based on the specific crank handle geometry.

The materials used for the attachment mechanism \hat{ }30 may be selected for durability and corrosion resistance to withstand frequent use in various environmental conditions. For example, stainless steel components may be used for the clamps, while the magnets may be coated or encased in protective materials.

### C. A Tool Interface

The device \hat{ }00 may further include a tool interface \hat{ }40 configured to operably connect the bracket \hat{ }02 to a motorized tool, such as a drill. While the bracket \hat{ }02 is connected to a crank handle, rotation of the bracket via the tool interface \hat{ }40 using the motorized tool may result in rotation of the handle (and thus, adjustment of the landing gear).

The tool interface \hat{ }40 may comprise a protrusion \hat{ }42 extending orthogonally from the first member \hat{ }04 near the junction point with the second member \hat{ }10. The protrusion \hat{ }42 may include an aperture \hat{ }44 dimensioned to receive and retain a drive shaft of a motorized tool. In some embodiments, the aperture \hat{ }44 may be threaded to securely engage with the drive shaft. Alternatively, the aperture \hat{ }44 may have a shape that include one or more flat sides (e.g., a square, as shown in FIG. XXX), and the drive shaft of the motorized tool may be fitted with a bit having a mating shape. The aperture may be sized to accommodate common drive shaft sizes, such as ¼ inch, ⅜ inch, or ½ inch drive shafts.

The protrusion \hat{ }42 may extend outward from the first member \hat{ }02 by approximately 1-2 inches to provide sufficient clearance for the motorized tool to operate without interference. The protrusion \hat{ }42 may be integrally formed with the first member. Alternatively, the protrusion \hat{ }42 may be formed as a separate component that is securely attached (e.g., via one or more fasteners and/or one or more welds). In some embodiments, the protrusion \hat{ }42 may be reinforced or gusseted where it joins the first member to withstand the torque forces applied during operation.

The aperture \hat{ }44 in the protrusion \hat{ }42 may be aligned coaxially with the rotational axis of the crank handle when the device is attached. This alignment allows for efficient transfer of rotational force from the motorized tool to the crank handle, via the device \hat{ }00. In some embodiments, the aperture \hat{ }44 may include a keyed or splined interface to prevent slippage between the drive shaft and the aperture during high-torque applications.

The material composition of the protrusion \hat{ }42 and/or the aperture \hat{ }44 may be selected to provide durability and wear resistance. High-strength alloys or hardened steel may be utilized to withstand repeated use and high torque loads. In some embodiments, the aperture \hat{ }44 may include a replaceable bushing or insert to allow for easy maintenance or replacement of the drive interface \hat{ }40.

When the drive shaft of a motorized tool is inserted into the aperture \hat{ }44 and rotated, it may cause rotation of the attached crank handle. The secure engagement between the drive shaft and the aperture, combined with the device's attachment to the crank handle, may enable efficient transfer of torque to adjust the landing gear height. This configuration may allow for quick, powered operation of the landing gear while maintaining stability and control.

### III. Platform Operation

Embodiments of the present disclosure provide device operative by a set of methods. The following depicts an example of at least one method of a plurality of methods that may be performed using the device.

Although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

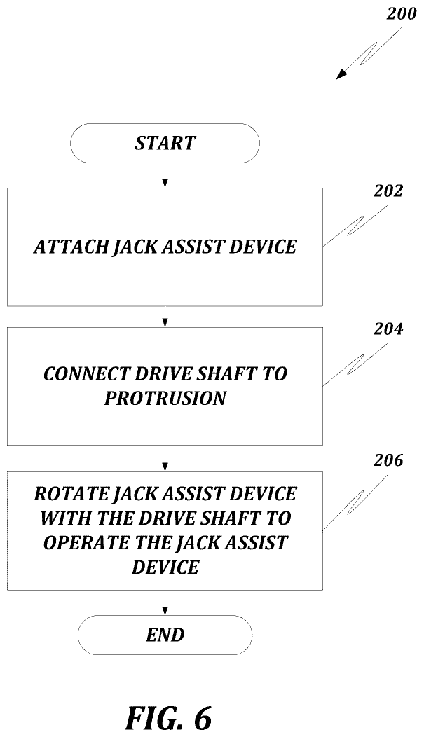

FIG. 6 is a flow chart setting forth the general stages involved in a method @00 consistent with an embodiment of the disclosure for utilizing the jack assist device \hat{ }00. The method may comprise the following stages.

The method @00 may comprise attaching the jack assist device to a crank handle of a landing gear in stage @02. Attaching the device to the crank handle may include attaching a first member of the jack assist device to a first section of a crank handle of a semi-trailer landing gear using a first securing mechanism. The first member may have an inner side with an arced divot that spans the length of the inner side. This arced divot may be shaped to partially encapsulate the first section of the crank handle. The first securing mechanism may be disposed on the inner side of the first member and may be configured to releasably secure the first member to the crank handle.

Additionally or alternatively, attaching the jack assist device to the crank handle may comprise attaching a second member of the jack assist device to a second section of the crank handle using a second securing mechanism. The second member may extend orthogonally from the first member. The second member may have an inner side with an arced divot spanning its length, shaped to partially encapsulate the second section of the crank handle. The second securing mechanism may be disposed on the inner side of the second member and may be con figured to releasably secure the second member to the crank handle.

In some embodiments, at least one of the first securing mechanism or the second securing mechanism may comprise a magnet. The magnetic securing mechanism may allow for quick and easy attachment and detachment of the jack assist device to the crank handle. Alternatively, or additionally, at least one of the first securing mechanism or the second securing mechanism may comprise a clamp. The clamp may provide a secure mechanical connection between the jack assist device and the crank handle.

In some embodiments, attaching the jack assist device to the crank may further comprise adjusting at least one of the first securing mechanism or the second securing mechanism to fit the crank handle. This adjustment capability may allow the jack assist device to be used with various sizes and shapes of crank handles, enhancing its versatility.

After securing the jack assist device to the crank handle in stage @02, the method @00 may involve interfacing or connecting a drive shaft of a motorized tool with a drive attachment mechanism of the jack assist device in stage @04. The drive attachment mechanism may comprise an aperture dimensioned to receive the drive shaft. This aperture may be located on a protrusion extending orthogonally from the first member, proximate to the junction point of the first member and the second member.

In some embodiments, interfacing the drive shaft with the drive attachment mechanism may include aligning the drive shaft with the aperture and inserting the drive shaft into the aperture. Aligning the drive shaft may include aligning a keyed or splined portion of the drive shaft with a corresponding key in the aperture. Alternatively, interfacing the drive shaft with the drive attachment mechanism may include threading the drive shaft into the aperture to achieve a threaded engagement.

Once the drive shaft is interfaced with the drive attachment mechanism, the method may proceed to rotating the drive shaft (via the motorized tool) to cause rotation of the crank handle in stage @06. The rotation of the drive shaft may cause the first member and the second member to rotate together, thereby rotating the attached crank handle.

In various embodiments, the motorized tool used to rotate the drive shaft may be, as examples, a handheld drill, auger, and/or other rotary tool. The use of a handheld drill may allow for efficient and powerful rotation of the crank handle, reducing the physical effort required by the operator.

In some embodiments, the method @00 may include a step of releasing at least one of the first securing mechanism or the second securing mechanism using a quick-release feature. This quick-release feature may facilitate rapid attachment and detachment of the jack assist device, improving operational efficiency.

In this way, an operator may efficiently and effectively use the jack assist device to rotate the crank handle of a semi-trailer landing gear, reducing physical strain and improving overall operational efficiency.

The following is claimed:

1. A jack assist device, comprising:
a first member configured to attach to a crank handle of a semi-trailer landing gear, the first member comprising:
an inner side having an arced divot spanning a length of the inner side;
an outer side; and
a first securing mechanism disposed on the inner side and configured to releasably secure the first member to a first section of the crank handle;
a second member extending orthogonally from the first member, the second member comprising:
an inner side having an arced divot spanning a length of the inner side;
an outer side; and
a second securing mechanism disposed on the inner side and configured to releasably secure the second member to a second section of the crank handle; and
a drive attachment mechanism configured to receive a drive shaft of a motorized tool,
wherein rotation of the drive shaft causes rotation of the crank handle.

2. The jack assist device of claim 1, wherein the drive attachment mechanism comprises an aperture dimensioned to receive the drive shaft.

3. The jack assist device of claim 1, wherein the drive attachment mechanism comprises a protrusion extending orthogonally from the first member proximate to a junction point of the first member and the second member.

4. The jack assist device of claim 1, wherein at least one of the first securing mechanism or the second securing mechanism comprises a magnet.

5. The jack assist device of claim 1, wherein at least one of the first securing mechanism or the second securing mechanism comprises a clamp.

6. The jack assist device of claim 1, wherein the drive attachment mechanism is threaded.

7. The jack assist device of claim 1, wherein rotation of the drive attachment mechanism causes rotation of the first member and the second member.

8. The jack assist device of claim 1, wherein at least one of the first securing mechanism or the second securing mechanism is adjustable.

9. The jack assist device of claim 1, wherein the motorized tool is a handheld drill.

10. The jack assist device of claim 1, wherein the first member and second member are made of a metal alloy.

11. The jack assist device of claim 1, wherein the first member comprises a series of pre-drilled holes for adjustable securing mechanisms.

12. The jack assist device of claim 1, wherein at least one of the first securing mechanism or the second securing mechanism comprises a quick-release feature.

13. The jack assist device of claim 1, wherein the second member is telescopic.

14. A method for operating a jack assist device, the method comprising:
attaching a first member of the jack assist device to a first section of a crank handle of a semi-trailer landing gear using a first securing mechanism;
attaching a second member of the jack assist device to a second section of the crank handle using a second securing mechanism, wherein the second member extends orthogonally from the first member;
interfacing a drive shaft of a motorized tool with a drive attachment mechanism of the jack assist device; and
rotating the drive shaft to cause rotation of the crank handle.

15. The method of claim 14, wherein the drive attachment mechanism comprises an aperture dimensioned to receive the drive shaft.

16. The method of claim 14, wherein at least one of the first securing mechanism or the second securing mechanism comprises a magnet or a clamp.

17. The method of claim 14, wherein the motorized tool is a handheld drill.

18. The method of claim 14, further comprising adjusting at least one of the first securing mechanism or the second securing mechanism to fit the crank handle.

19. The method of claim 14, further comprising releasing at least one of the first securing mechanism or the second securing mechanism using a quick-release feature.

20. An apparatus for rotating a crank handle of a semi-trailer landing gear, comprising:
a first L-shaped member configured to partially encapsulate the crank handle, the first L-shaped member comprising:
a first arm having an inner side with an arced divot;
a second arm extending orthogonally from the first arm and having an inner side with an arced divot;
at least one securing mechanism disposed on at least one of the first arm or the second arm and configured to releasably secure the first L-shaped member to the crank handle; and
a drive attachment mechanism configured to receive a drive shaft of a motorized tool,
wherein rotation of the drive shaft causes rotation of the crank handle.
